(19) United States
(12) Patent Application Publication
(10) Pub. No.: US 2026/0249319 A1
(43) Pub. Date: Aug. 27, 2026

(54) DEVICE AND METHOD FOR APPLYING AN APPLICATION MEDIUM TO A WORKPIECE

(71) Applicant: JOSEF SCHIELE, Niederzissen (DE)

(72) Inventors: Stefan Schiele, Niederzissen (DE); Matthias Gros, Niederzissen (DE)

(21) Appl. No.: 18/874,835

(22) PCT Filed: Jun. 14, 2023
(86) PCT No.: PCT/EP2023/066013

§ 371 Date: Dec. 13, 2024

(30) Foreign Application Priority Data
Jun. 15, 2022 (DE) 10 2022 206 051.2

(51) Int. Cl. B05C 1/08; B05C 1/00

(52) U.S. Cl. CPC B05C 1/08; B05C 1/006; B05C 1/0808; B05C 1/0813

(57) ABSTRACT

The invention relates to a device for applying an application medium, in particular a coating medium and/or a sealing medium, to a workpiece, in particular a flooring element, a door leaf or a covering panel, comprising a container for receiving a bath of the application medium, comprising a first rotatable transfer wheel which is designed to receive the application medium from the bath, and a second rotatable transfer wheel which is designed to apply the application medium received by the first transfer wheel to the workpiece. The invention also relates to a method for applying an application medium, in particular a coating medium and/or a sealing medium, to a workpiece, in particular a flooring element, wherein the application medium is received from a bath by means of a first rotatable transfer wheel, and wherein the application medium received by the first transfer wheel is applied to the workpiece by means of a second rotatable transfer wheel.

The present invention relates to a device for applying an application medium, in particular a coating medium and/or a sealing medium, to a workpiece. The invention also relates to a method for applying an application medium, in particular a coating medium and/or a sealing medium, to a workpiece.

Such devices are used, for example, in production apparatuses for manufacturing floor elements. When installed, floor elements may not be exactly aligned in terms of their height on account of manufacturing-related tolerance deviations or as a result of joining errors. In order to avoid the floor elements being a trip hazard and to make the floor elements smooth to walk across, they are typically provided with chamfers, i.e. beveled surfaces, at their edges. In addition to other, for example visual, criteria, chamfers meet the technical requirements of making transitions between joining edges of floor elements visually appealing and of avoiding accidents.

Such chamfers are often also provided in the case of workpieces designed as door leaves or as ceiling panels.

Typically, the chamfers are manufactured by milling and then coated and/or sealed with the application medium. In this case, the application medium is usually taken up from a container by a rotating transfer wheel. The workpiece to which the medium is applied is typically moved relative to the transfer wheel by a conveying apparatus, wherein the decorative side of the workpiece is directed downward. The transfer wheel transfers the application medium to the respective chamfer of the moving workpiece. This has the disadvantage that the application medium can reach the lower decorative side, which is adjacent to the chamfer, of the workpiece on account of the effect of gravity. The decorative side can therefore be adversely affected, in particular soiled, by the application medium during the application.

Against this background, the object is to provide a device that prevents the adverse effects on the decorative side that occur during coating, impregnation or sealing of a chamfer.

In order to achieve this object, a device for applying an application medium, in particular a coating medium and/or a sealing medium, to a workpiece, in particular a floor element, a door leaf or a ceiling panel,
having a container for receiving a bath of the application medium,
having a first rotatable transfer wheel, which is configured to take up the application medium from the bath,
having a second rotatable transfer wheel, which is configured to apply the application medium taken up by the first rotatable transfer wheel to the workpiece, is proposed.

The device according to the invention has a container for receiving a bath of the application medium. The application medium is taken up from the bath using a first transfer wheel, which functions as a take-up wheel and is mounted so as to be rotatable about a first axis of rotation. For this purpose, the first transfer wheel is at least partially brought into physical contact with the application medium in the bath. The application medium can be applied to the workpiece, in particular to a chamfer of a floor element of the door leaf or of the ceiling panel, using a second transfer wheel, which functions as an application wheel and is mounted so as to be rotatable about a second axis of rotation. Using two transfer wheels offers the possibility that the second transfer wheel can have a different orientation than the first transfer wheel. For example, it is conceivable for the two transfer wheels to be designed so as to have different inclinations and/or to be tiltable relative to one another, in order to be able to coat, impregnate, seal or the like different chamfer angles. In particular, the second transfer wheel can be arranged horizontally, i.e. substantially in a plane perpendicular to gravity. A horizontal arrangement of the second transfer wheel can have the advantage that workpieces, in particular floor elements, door leaves or ceiling panels, the decorative side of which is facing upward, can be coated. This allows chamfers on the top side of the workpieces, i.e. on a side of the workpieces facing away from the direction of gravity, to be processed. The top side, which functions as the decorative side of the workpiece, can advantageously be protected against unwanted contamination, since the application medium can run off along the chamfer or along the chamfer angle under the effect of the Earth's gravity. Consequently, the application medium can, for the most part, run off into portions of the workpiece that are less relevant to the appearance, technology and quality of the workpieces, without affecting the decorative side. As a result, the decorative side can go through the manufacturing process without the appearance, technology and quality being affected.

One advantageous configuration of the invention makes provision for the second transfer wheel to be configured to take up the application medium taken up by the first transfer wheel directly from the first transfer wheel. The application medium taken up from the bath by the first transfer wheel through physical contact can be transferred contactlessly, through adhesion forces alone, to the second transfer wheel. In other words, the first and second transfer wheels can be spaced apart at their respective circumference. Directly transferring the application medium from the first transfer wheel to the second transfer wheel enables any application medium losses to be reduced and consequently the efficiency of the device to be increased.

One preferred configuration of the invention makes provision for at least one third rotatable transfer wheel, which is configured to transfer the application medium taken up by the first rotatable transfer wheel to the second transfer wheel, wherein the second transfer wheel is configured to take up the application medium taken up by the first transfer wheel from the at least one third transfer wheel. The application medium can be indirectly transferred from the first to the second transfer wheel by means of a third transfer wheel. Consequently, elements, apparatuses and the like that are structurally required and formed within the device but make it difficult to directly transfer the application medium from the first to the second transfer wheel can advantageously be spatially bypassed or circumvented. A plurality of third transfer wheels of different dimensions and arrangements are conceivable. An increased number of transfer wheels enables more complex paths for transferring the application medium from the bath to the workpiece, in particular to the chamfer of a floor element, door leaf or of a ceiling panel, to be realized. The application medium taken up from the bath by the first transfer wheel through physical contact can be transferred contactlessly, through adhesion forces alone, to the one or the plurality of third transfer wheels. Likewise, the application medium can be transferred contactlessly between a plurality of third transfer wheels. Furthermore, it is preferred if the application medium is transferred from the one or the plurality of third transfer wheels to the second transfer wheel contactlessly.

According to one advantageous embodiment of the invention, provision is made for the device to have a take-up region, in which the application medium can be taken up on the second rotatable transfer wheel, and has an application region, in which the application medium can be applied to the workpiece by the second rotatable transfer wheel, wherein the take-up region is arranged higher in the direction in which the Earth's gravitational pull acts than the application region. As a result of a higher arrangement of the take-up region relative to the application region, the second transfer wheel can be inclined or tilted. Consequently, chamfers on a top side of the workpiece can advantageously be coated, impregnated or sealed. As a result, the decorative side can remain free of defects.

According to an alternative embodiment of the invention, provision is made for the device to have a take-up region, in which the application medium can be taken up on the second rotatable transfer wheel, and has an application region, in which the application medium can be applied to the workpiece by the second rotatable transfer wheel, wherein the take-up region is arranged at the same height in the direction in which the Earth's gravitational pull acts as the application region. If the take-up region and application region are arranged at the same height, the transfer wheel can be horizontal, i.e. in a plane perpendicular to the direction of gravitational acceleration. The same advantages apply for a horizontal second transfer wheel as for the inclined second transfer wheel in which the take-up region is arranged higher than the application region.

One advantageous configuration of the invention makes provision for the transfer wheels to each have a disk-like portion each having a first and a second side face, wherein the side faces have a circular design and are arranged parallel to one another, wherein the two side faces of each transfer wheel each have a different diameter. A different diameter of the first side face enables a different centrifugal force to act on the application medium at a circumferential line of the first side face than at a circumferential line of the parallel second side face. Furthermore, in the case of different diameters of the two side faces, a connecting portion of the two circumferential lines can be non-perpendicular to the side faces. Adjusting the two diameters enables the connecting portion to be geometrically adapted to the chamfer of the workpiece. The application medium can mainly be taken up and released via the connecting portions of a respective transfer wheel.

According to one configuration of the invention, provision is made for all of the transfer wheels to each have a circumferential face, wherein at least one of the circumferential faces has contouring. The circumferential faces of the respective transfer wheels can have multifarious configurations between the circumferential lines of their two side faces. For example, the circumferential faces can have a smooth configuration. In other words, the disk-like portions of the transfer wheels can be designed as frustra, wherein the side faces of the transfer wheels correspond to the base face and top face of the frustrum, and the circumferential faces of the transfer wheels correspond to the lateral surface of the frustrum. Moreover, the circumferential faces can have contouring, i.e. not be smooth. The contouring can preferably be adapted to the profile of the workpiece or floor element, of the door leaf or of the ceiling panel. The contouring can have elevations or protrusions and recesses in the circumferential face.

In one advantageous configuration of the invention, provision is made for all of the transfer wheels to each have a circumferential face, wherein at least one of the circumferential faces comprises an absorbent transfer element, in particular foam rubber. By means of a transfer element arranged on a circumferential face of a transfer wheel, the application medium can advantageously be transferred with contact to a further transfer wheel or the workpiece. The application medium can be temporarily stored in pores of the—preferably elastic and/or resilient—transfer element. As a result of the intermediate storage, application medium loss, for example through dripping, can at least be reduced and the efficiency of the transfer can be increased. Transfer elements can have different degrees of porosity. Furthermore, transfer elements can be arranged on both smooth and contoured circumferential faces.

According to one configuration of the invention, provision is made for a housing, which comprises all of the transfer wheels, wherein the second transfer wheel protrudes at least partially via a housing opening. A housing can protect the transfer wheels, the bath, the application medium and other components of the device against ingress of undesired substances, particles and the like. Furthermore, accommodating a multiplicity of components within a common housing can facilitate transportation and assembly. Moreover, the last transfer wheel arranged in the path of action of all of the transfer wheels, the second transfer wheel, protrudes from the housing through a housing opening, in order to coat, impregnate or seal a chamfer of the workpiece or floor element, of the door leaf or of the ceiling panel.

A further development of the immediately preceding embodiment of the invention makes provision for a supply line for supplying a medium, in particular moist air, into a housing interior in order to produce an overpressure in the housing interior. Supplying a gaseous medium into the housing interior of the device can generate a slight overpressure with respect to the immediate ambient atmosphere. The overpressure can advantageously prevent the ingress of contaminants from the surroundings, for example dust, into the housing interior. Since the medium simultaneously escapes via the housing opening, a greater volumetric or mass flowrate of medium can be supplied to the housing interior than can flow out via the housing opening in order to maintain the overpressure. In order to adjust a desired overpressure, in addition to adjusting the volumetric flowrate of the medium, the cross section or the size of the housing opening can also be selected or defined during the design phase. It is conceivable—analogously to an aperture—for the housing opening to have a variable cross section, for example by means of an element that can be folded or displaced along a housing guide in order to increase or reduce the size of the housing opening. Furthermore, when using moist air as the medium, the advantage can be achieved that, in particular when using waterborne paints, the application medium does not dry out.

According to one configuration of the invention, provision is made for a cooling apparatus for controlling the temperature of the application medium. The device can have a wall in which a cooling channel for passage of a coolant is arranged. Depending on the application, different process temperatures of the application medium may be necessary. Consequently, a coolant, which is conveyed through a cooling channel in a wall of the container, can preferably be used for controlling the temperature. For uniform and large-scale cooling performance, the cooling channel can have a meandering design. Furthermore, the cooling channel can be formed on at least two, in particular opposite, sides of the wall. For a compact structure, on the one hand, and good attachment of the cooling channel to a tank, on the other hand, a supply port and discharge port of the cooling channel can be formed on the same side of the device.

One advantageous configuration of the invention makes provision for at least one scraper for scraping the application medium from at least one of the transfer wheels, preferably from the first or from the second transfer wheel. For optimal coating, impregnation or sealing, the correct amount of application medium is required on the intended portions, for example joining faces or chamfers. The scraper can scrape excess volumes of application medium from the transfer wheel. Preferably, the amount to be scraped can be adjusted by changing the position of the scraper relative to the transfer wheel.

Another subject of the invention proposes a method for applying an application medium, in particular a coating medium and/or a sealing medium, to a workpiece, in particular a floor element, a door leaf or a ceiling panel,
wherein the application medium is taken up from a bath by means of a first rotatable transfer wheel, and
wherein the application medium taken up by the first transfer wheel is applied to the workpiece by means of a second rotatable transfer wheel.

In the case of the method, the same advantages can be achieved as have already been described in connection with the application device according to the invention and the production apparatus.

According to one advantageous configuration of the method, provision is made for the application medium to be transferred between the transfer wheels and from the second transfer wheel to the workpiece contactlessly. Alternatively, the application medium can be transferred between the transfer wheels and/or from the second transfer wheel to the workpiece with contact.

According to one advantageous configuration of the method, provision is made for the transfer wheels to be driven at a different angular velocity. Different angular velocities are generally associated with different circumferential velocities of the transfer wheels. In particular in the case of the application medium being transferred with contact from one transfer wheel to another—or to the workpiece—a difference in the angular velocities can promote the transfer of the application medium through friction. In particular when using transfer elements arranged on the circumferential faces of the transfer wheels, the application medium temporarily stored in the pores—or in the imperfections of the surface—of the transfer element can be transported or pressed out of the pores through physical contact.

In one preferred configuration of the invention, provision is made for the transfer wheels to be driven in counter-rotation. In particular in the case of the application medium being transferred with contact from one transfer wheel to another—or to the workpiece—the counter rotation of the transfer wheels can be beneficial for transferring the application medium, since the friction between the transfer wheels as a result of the counter rotation or as a result of the increase in relative velocity between the transfer wheels at their circumferential lines is increased.

As an alternative or in addition to the above-explained advantageous configurations, the advantageous configurations and features explained in connection with the device according to the invention can be used in the method.

Further details and advantages of the invention will be explained below on the basis of the exemplary embodiments shown in the figures, in which:

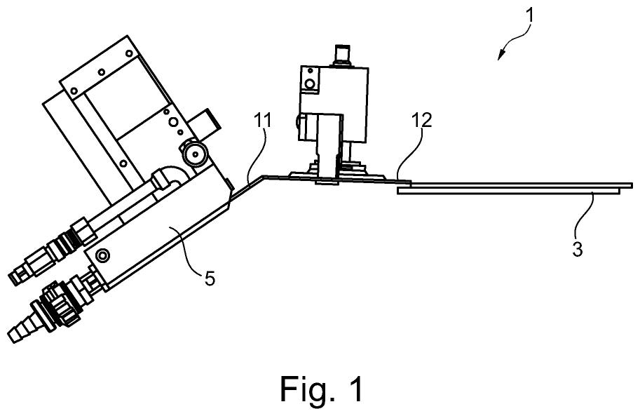

FIG. 1 shows a device according to a first exemplary embodiment of the invention in a side view;

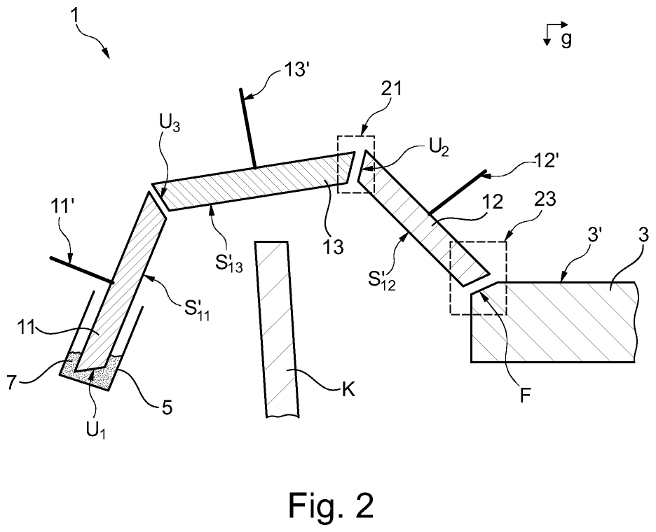

FIG. 2 shows a schematic sectional illustration of the device according to a second exemplary embodiment of the invention;

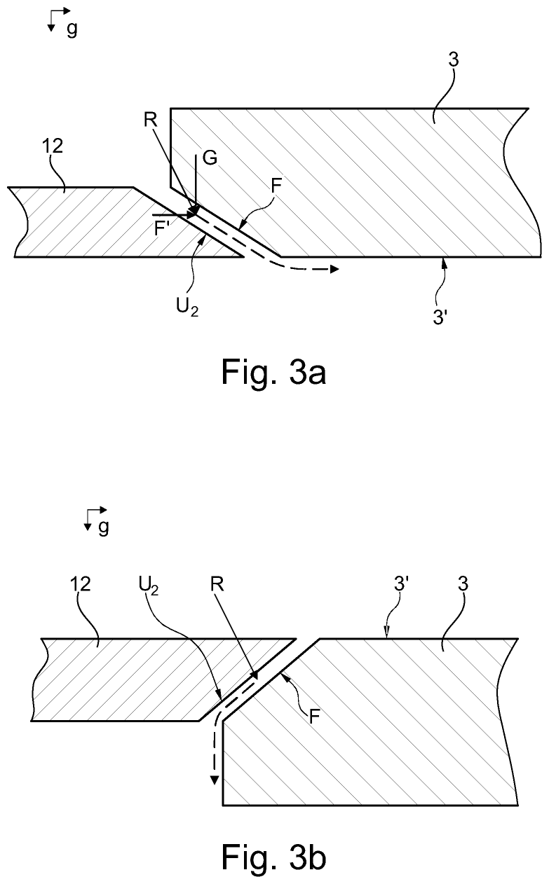

FIG. 3a shows a schematic detail view of an application region of the device having a decorative side, facing in the direction of gravitational acceleration, of a workpiece in a side view;

FIG. 3b shows a schematic detail view of an application region of the device having a decorative side, facing away from the direction of gravitational acceleration, of the workpiece in a side view;

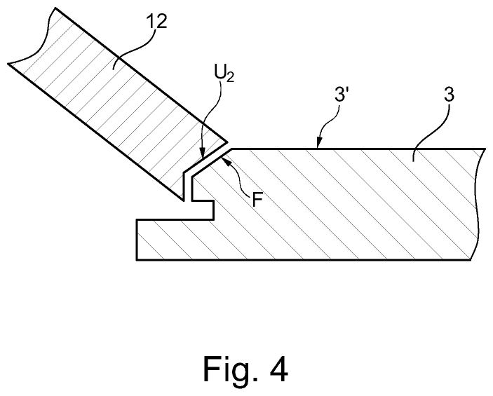

FIG. 4 shows a schematic detail view of an application region of the device having a contoured transfer wheel in a side view.

FIG. 1 illustrates a first configuration of a device 1 according to the invention for applying an application medium, in this case a water-based paint, to a workpiece 3, in this case a floor element 3. The device 1 comprises a first rotatable transfer wheel 11, which is arranged, at least partially, in a container 5. A bath 7, which is arranged within the container 5 and cannot be seen in FIG. 1, comprises the application medium, which is taken up by the first transfer wheel 11 by rotation about a first axis of rotation 11′, wherein the first axis of rotation 11′ is illustrated in FIG. 2. Furthermore, the device 1 has a second rotatable transfer wheel 12, wherein the second transfer wheel 12 is designed to be rotatable about a second axis of rotation 12′, which is likewise shown in FIG. 2.

The application medium can be transferred from the first transfer wheel 11 to the second transfer wheel 12 by adhesion forces. Subsequently, the application medium can be applied by the second transfer wheel 12 to a chamfer F of the floor element 3 by adhesion forces. As a result of the application, the chamfer F is painted and protected against external influences such as moisture and dirt.

FIG. 2 illustrates a schematic sectional illustration of the device 1 according to a second exemplary embodiment of the invention. In addition to the first transfer wheel 11 and the second transfer wheel 12, the second embodiment of the device 1 also comprises a third transfer wheel 13. The third transfer wheel 13 is mounted so as to be rotatable about a third axis of rotation 13′ and is arranged between the first and the second transfer wheel 11, 12. All three transfer wheels 11, 12, 13 each have a first side face S₁₁′, S₁₂′, S₁₃′ and a second side face S₁₁″, S₁₂″, S₁₃″, wherein all of the side faces S₁₁′, S₁₂′, S₁₃′, S₁₁″, S₁₂″, S₁₃″ have a circular design. The side faces S₁₁′, S₁₂′, S₁₃′, S₁₁″, S₁₂″, S₁₃″, which are each associated with a transfer wheel 11, 12, 13, are arranged parallel to one another. A smooth circumferential face U₁, U₂, U₃ is formed in each case between the two side faces S₁₁′, S₁₂′, S₁₃′, S₁₁″, S₁₂″, S₁₃″ of each transfer wheel 11, 12, 13, with the result that each transfer wheel 11, 12, 13 is designed as a frustrum. In other words, the first side faces S₁₁′, S₁₂′, S₁₃′ have a different diameter than the second side faces S₁₁″, S₁₂″, S₁₃″, with the result that the circumferential faces U₁, U₂, U₃ are not oriented perpendicular to the associated side faces S₁₁′, S₁₂′, S₁₃′, S₁₁″, S₁₂″, S₁₃″.

The first transfer wheel 11 takes up the application medium from the bath 7, which is not depicted in FIG. 2, and transfers it via its circumferential face U₁ to the third transfer wheel 13 or to the circumferential face U₃ of the third transfer wheel 13. Then, in a take-up region 21 of the device 1, the application medium is transferred from the circumferential face U₃ of the third transfer wheel 13 to the circumferential face U₂ of the second transfer wheel 12. In an application region 23 of the device 1, the medium is applied, i.e. the application medium is transferred from the circumferential face U₂ of the second transfer wheel 12, to a chamfer F of the floor element 3. The take-up region 21 is arranged higher than the application region 21, with the result that the chamfer F and a decorative side 3′ of the floor element 3 are arranged on a side of the floor element 3 facing away from the direction of gravitational acceleration \vec{g}. In other words, the chamfer F and the decorative side 3′ are arranged on a top side of the floor element 3. Disadvantages of processing the floor element 3 when the chamfer F and the decorative side 3′ are arranged on an underside will be discussed in the description of FIG. 3a and FIG. 3b.

The configuration of the invention having more than two transfer wheels 11, 12, as illustrated in FIG. 2, for example, is suitable in particular for bypassing interference contours K of the device 1. A plurality of third transfer wheels 13 are also conceivable for bypassing interference contours.

Both in FIG. 3a and in FIG. 3b, the application region 23 of the device 1 is illustrated schematically with a second transfer wheel 12 arranged in each case horizontally, i.e. in a plane perpendicular to the gravitational acceleration \vec{g}. According to FIG. 3a, the decorative side 3′ is arranged below the floor element 3. The application medium, which is arranged in a gap between the circumferential face U₂ and the chamfer F of the floor element 3 and is not illustrated, is subject to a centrifugal force F′ as a result of the rotation of the second transfer wheel 12. Furthermore, a gravitational force G acts on the application medium in the direction of gravitational acceleration \vec{g}. A force R resulting from the centrifugal force F′ and the gravitational force G in combination with geometric and manufacturing-related circumstances can, at least to some extent, cause the application medium to run off onto the decorative side 3′ and consequently adversely affect the appearance, haptics and technology of the latter. The run-off of the application medium is illustrated by a dashed free-hand arrow. In this respect, this embodiment illustrated in FIG. 3a represents a suboptimal solution.

FIG. 3b shows an application situation that can be realized using the application device according to the invention. The second transfer wheel 12 can be arranged in such a manner that application to an upwardly facing chamfer F is possible. The decorative side 3′ of the floor element 3 can face upward. The application medium can run off downward under the influence of the resultant force, as a result of which the decorative side 3′, which is arranged on a top side of the floor element 3 in FIG. 3b, remains unaffected by the application medium. Excess amounts of application medium, which could cause the application medium to rise along the gap between the circumferential face U₂ and the chamfer F, can advantageously be prevented by controlling the amount by means of a scraper, which is in particular arranged on the first transfer wheel 11.

FIG. 4 schematically illustrates a contoured second transfer wheel 12 in a side view. In other words, the circumferential face U₂ is geometrically adapted to the floor element 3. Excess amounts of application medium can advantageously be prevented by means of a scraper, which is in particular arranged on the second transfer wheel 12.

The above-explained exemplary embodiments show devices 1 for applying an application medium, in particular a coating medium and/or a sealing medium, to a workpiece 3, in particular a floor element, having a container 5 for receiving a bath 7 of the application medium, having a first rotatable transfer wheel 11, which is configured to take up the application medium from the bath 7, and having a second rotatable transfer wheel 12, which is configured to apply the application medium taken up by the first rotatable transfer wheel 11 to the workpiece 3.

According to one modification of the above-explained exemplary embodiment, the device can be configured for applying an application medium to a door leaf or to a ceiling panel.

### REFERENCE SIGNS

1 Device
3 Workpiece
3′ Decorative side
5 Container
7 Bath
11 First transfer wheel
11′ First axis of rotation
12 Second transfer wheel
12′ Second axis of rotation
13 Third transfer wheel
13′ Third axis of rotation
21 Take-up region
23 Application region
F Chamfer
F′ Centrifugal force
G Gravitational force
K Interference contour
R Resultant force
S₁₁′ First side face of the first transfer wheel
S₁₂′ First side face of the second transfer wheel
S₁₃′ First side face of the third transfer wheel
S₁₁″ Second side face of the first transfer wheel
S₁₂″ Second side face of the second transfer wheel
S₁₃″ Second side face of the third transfer wheel
Uᵢ Circumferential faces

1. A device for applying an application medium to a workpiece comprising:
a) a container for receiving a bath of the application medium;
b) a first rotatable transfer wheel, which is configured to take up the application medium from the bath; and
c) a second rotatable transfer wheel, which is configured to apply the application medium taken up by the first rotatable transfer wheel to the workpiece.

2. The device as claimed in claim 1, wherein the second transfer wheel is configured to take up the application medium taken up by the first transfer wheel directly from the first transfer wheel.

3. The device as claimed in claim 1, comprising at least one third rotatable transfer wheel, which is configured to transfer the application medium taken up by the first rotatable transfer wheel to the second transfer wheel, and wherein the second transfer wheel is configured to take up the application medium taken up by the first transfer wheel from the at least one third transfer wheel.

4. The device as claimed in claim 1, wherein the device has a take-up region, in which the application medium can be taken up on the second rotatable transfer wheel, and has an application region, in which the application medium can be applied to the workpiece by the second rotatable transfer wheel, wherein the take-up region is arranged higher in a direction in which the Earth's gravitational pull acts than the application region.

5. The device as claimed in claim 1, wherein the device has a take-up region, in which the application medium can be taken up on the second rotatable transfer wheel, and has an application region, in which the application medium can be applied to the workpiece by the second rotatable transfer wheel, wherein the take-up region is arranged at a same height in a direction in which the Earth's gravitational pull acts as the application region.

6. The device as claimed in claim 1, wherein the transfer wheels each have a disk-like portion each having a first and a second side face, wherein the side faces have a circular design and are arranged parallel to one another, wherein the two side faces of each transfer wheel each have a different diameter.

7. The device as claimed in claim 1, wherein the transfer wheels each have a circumferential face, wherein at least one of the circumferential faces has contouring.

8. The device as claimed in claim 1, wherein the transfer wheels each have a circumferential face, wherein at least one of the circumferential faces comprises an absorbent transfer element.

9. The device as claimed in claim 1, including a housing, which comprises the transfer wheels, wherein the second transfer wheel protrudes at least partially via a housing opening.

10. The device as claimed in claim 9, including a supply line for supplying moist air into a housing interior in order to produce an overpressure in the housing interior.

11. The device as claimed in one claim 1, including a cooling apparatus for controlling the temperature of the application medium.

12. The device as claimed in claim 1, including at least one scraper for scraping the application medium from at least one of the transfer wheels.

13. A method for applying an application medium to a comprising:
taking up the application medium from a bath with a first rotatable transfer wheel, and
applying the application medium taken up by the first transfer wheel to the workpiece with a second rotatable transfer wheel.

14. The method as claimed in claim 13, wherein the application medium is transferred between the transfer wheels and from the second transfer wheel to the workpiece contactlessly.

15. The method as claimed in claim 13, wherein the transfer wheels are driven at a different angular velocity.

16. The method as claimed in claim 13, wherein the transfer wheels are driven in counter-rotation.

17. The device as claimed in claim 1, wherein the application medium is a coating medium and/or a sealing medium.

18. The device as claimed in claim 1, wherein the workpiece is a floor element, a door leaf, or a ceiling panel.

19. The method as claimed in claim 13, wherein the application medium is a coating medium and/or a sealing medium.

20. The method as claimed in claim 13, wherein the workpiece is a floor element, a door leaf, or a ceiling panel.
